(19) United States
(12) Patent Application Publication
(10) Pub. No.: US 2008/0145087 A1
(43) Pub. Date: Jun. 19, 2008

(54) Image forming apparatus and method for warming up the same

(75) Inventor: Shigeharu Itou, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/999,776

(22) Filed: Dec. 7, 2007

(30) Foreign Application Priority Data
Dec. 19, 2006 (JP) 2006-341337

(51) Int. Cl. G03G 15/20

(52) U.S. Cl. 399/70

(57) ABSTRACT

A warm-up execution portion 102 sets whether or not a color adjustment process is executed at a time of execution of a warm-up process. The warm-up execution portion (102) executes the warm-up process including a prescribed color adjustment process executed by forming a predetermined toner image on an image forming section (190) at a time of resume from a sleep mode or at a time of activating an image forming apparatus (10). When a setting portion (103) is set that the color adjustment process is not to be executed, the image forming section (190) is allow to execute the warm-up process excluding the color adjustment process.

### BACKGROUND OF THE INVENTION

1. Field of the Invention

The present invention relates to an image forming apparatus and a method for warming up the same.

2. Description of the Related Art

Recently, there has been a known image forming apparatus in which a warm-up process of heating a fixing roller and detecting a color offset of toner images of respective colors constituting a color image are executed for a favorable image forming at a time of activating the apparatus.

For example, Japanese Patent Unexamined Publication No. 10-148979 (patent document 1) discloses a density adjustment of detecting a temperature of a fixing device immediate after power activation or immediate after resume from a power-saving mode, and forming a patch image when the detected temperature is lower than a prescribed temperature, and measuring a density of the patch image for allowing the density of a toner image to reach a target density.

However, while the density adjustment process is always executed when the temperature of the fixing device is lower than the target temperature according to the method disclosed in the patent document 1, a color adjustment process like the density adjustment process would not be necessary at a time of execution of a warm-up process if an image forming apparatus is capable of forming a color and a B/W (black & white) image but mainly forms a B/W image. In such case, toners are wasted.

An object of the present invention is to provide an image forming apparatus capable of preventing wasteful consumption of toners.

### SUMMARY OF THE INVENTION

An image forming apparatus in accordance with the present invention comprises: an image forming unit, which forms a B/W or a color image on a recording paper; a warm-up execution unit, which executes a warm-up process including a prescribed color adjustment process by forming a certain toner image on the image forming unit at a time of resume from a sleep mode or at a time of activating the apparatus; and a setting unit, which enables a setting if said color adjustment process is to be executed or not at the time of execution of the warm-up process. Said warm-up execution unit executes said warm-up process to the image forming unit excluding the color adjustment process when the setting unit is set that the color image process is not executed.

According to this configuration, when it is set that the color adjustment process by forming a certain toner image on the image forming unit is not executed at the time of execution of the warm-up process, the warm-up process excluding the color adjustment process is executed. Accordingly, the color adjustment process is not executed at the time of execution of the warm-up process in the image forming apparatus which mainly performs printing of a B/W images, so that wasteful consumption of toners can be prevented.

These and other objects, features and advantages of the present invention will become apparent upon reading of the following detailed description along with the accompanied drawings.

### BRIEF DESCRIPTION OF DRAWINGS

FIG. 1 is a side view schematically showing a mechanical configuration of an image forming apparatus in accordance with the present embodiment.

FIG. 2 is a block diagram showing an electrical configuration of the image forming apparatus.

FIG. 3 shows color offset detection marks which are formed on an intermediate transferring roller at a time of execution a color offset detection process.

FIG. 4 is a flowchart showing processes which are executed at a time of execution of a warm-up process excluding a color adjustment process.

FIG. 5 is a flowchart showing processes which are executed at a time of execution of the warm-up process including the color adjustment process.

### DETAILED DESCRIPTION OF THE PREFERRED EMBODIMENT

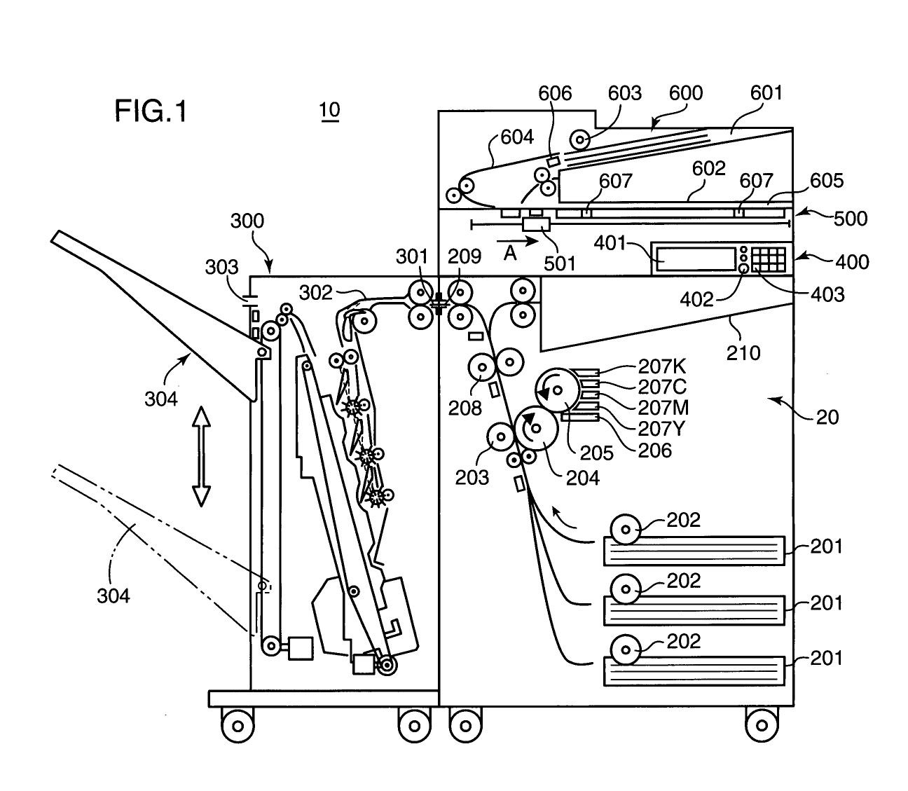

Hereinafter, an embodiment in accordance with the present invention will be described with reference to the drawings. FIG. 1 is a side view schematically showing a mechanical configuration of an image forming apparatus 10 in accordance with the present embodiment. The image forming apparatus 10 includes a main body section 20, a sheet post-processing section 300 arranged on the left side of the main body section 20, an operating section 400 for allowing a user to input various kinds of operating instructions and the like, a document reading section 500 arranged in an upper portion of the main body section 20, and a document feeding section 600 arranged on the document reading section 500.

The operating section 400 has an operation panel 401, a start key 402, and numerical keys 403. The operation panel 401 displays various kinds of operation screens and various kinds of operation buttons and the like for allowing a user to input various kinds of operating instructions. The start key 402 is used for allowing a user to input a print execution instruction and the like. The numerical keys 403 are used for inputting the number of copies and the like.

The document feeding section 600 has a document holding portion 601, a document discharging portion 602, a sheet feeding roller 603, a document conveying portion 604, a contact glass 605, and document detection sensors 606, 607. The document reading section 500 has a scanner 501. The sheet feeding roller 603 feeds documents set on the document holding portion 601, and the document conveying portion 604 conveys the fed documents onto the scanner 501 one after another. The scanner 501 reads the conveyed documents one after another, and the read documents are discharged to the document discharging portion 602. Further, in a case of reading documents placed on the contact glass 605, the scanner 501 slides in a direction A to read the documents. A plurality of document detection sensors 606 are arranged in a width direction of recording paper (a direction perpendicular to the page of drawing) a predetermined distance apart. A plurality of document detection sensors 607 are arranged under the contact glass 605.

The main body section 20 has a plurality of sheet-feeding cassettes 201, a plurality of sheet feeding rollers 202, a transferring roller 203, an intermediate transferring roller 204, a photoconductive drum 205, an exposing device 206, developing devices 207Y, 207M, 207C, 207K for respective colors of yellow, magenta, cyan, and black, a fixing roller 208, a sheet-discharging slot 209, and a sheet-discharging tray 210. In the present embodiment, the sheet-feeding cassettes 201 accommodate recording paper of sizes different from one another.

The photoconductive drum 205 is uniformly charged with electricity by a charging device (not illustrated) while it rotates in a direction of arrow. The exposing device 206 converts modulation signals created in accordance with image data of a document read out in the document reading section 500 to a laser light and outputs the same to form electrostatic latent images for respective colors on the photoconductive drum 205. The developing devices 207Y, 207M, 207C, 207K supply developers of respective colors to the photoconductive drum 205 to form toner images of respective colors.

Onto the intermediate transferring roller 204, toner images of respective colors are transferred from the photoconductive drum 205, so that color toner images are formed on the intermediate transferring roller 204.

On the other hand, the sheet feeding roller 202 takes out recording paper from the sheet-feeding cassette 201 accommodating the recording paper, and conveys the taken recording paper to the transferring roller 203. The transferring roller 203 allows the toner images formed on the intermediate transferring roller 204 to be transferred to the conveyed recording paper. The recording paper with the toner images are conveyed to the fixing roller 208. The fixing roller 208 heats the transferred toner images to fix them on the recording paper. Thereafter, the recording paper is conveyed to the discharging slot 209 and then conveyed into the sheet post-processing section 300. The recording paper is discharged also to the sheet-discharging tray 210 when necessary.

The sheet post-processing section 300 has a conveying-in slot 301, a recording paper conveying portion 302, a conveying-out slot 303, and a stack tray 304. The recording paper conveying portion 302 successively conveys recording paper conveyed from the discharging slot 209 through the conveying-in slot 301, and discharges the recording sheet to the stack tray 304 through the conveying-out slot 303 at last. The stack tray 304 is so configured to be vertically movable in directions of arrows in accordance with the number of stacked recording paper conveyed out through the conveying-out slot 303.

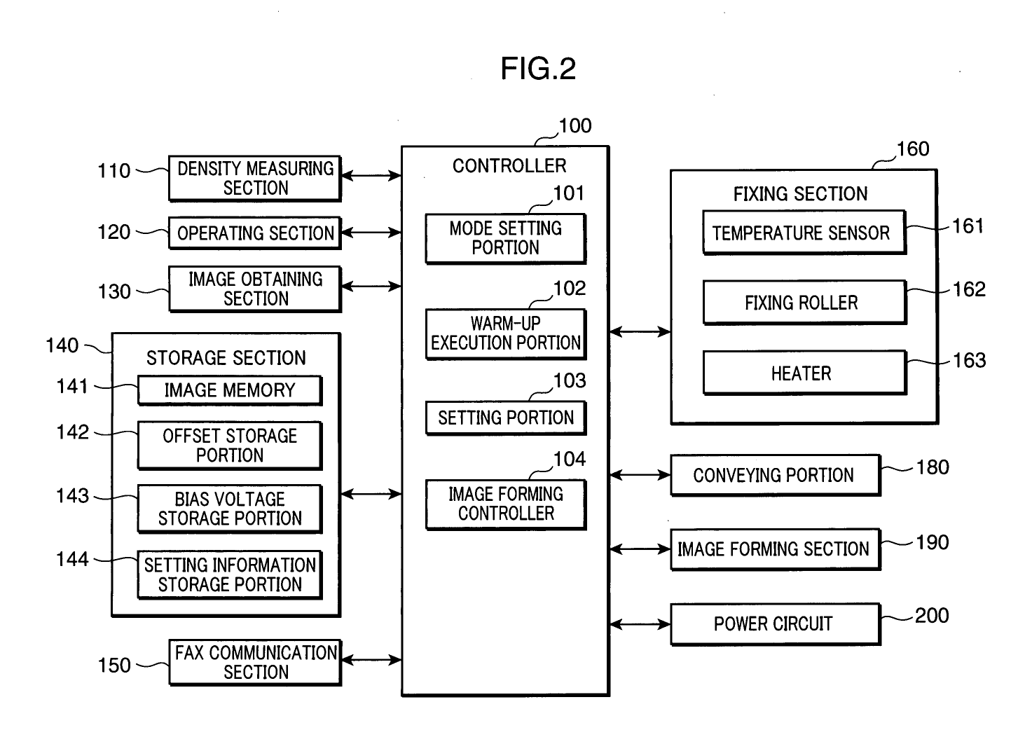

FIG. 2 is a block diagram showing an electrical configuration of the image forming apparatus 10. As shown in FIG. 2, the image forming apparatus 10 includes a controller 100, a density measuring section 110, an operating section 120, an image obtaining section 130, a storage section 140, a FAX communication section 150, a fixing section 160, a conveying section 180, an image forming section 190 (image forming unit), and a power circuit 200.

The controller 100 has a CPU (Central Processing Unit), a ROM (Read Only Memory), and a RAM (Random Access Memory), and it executes a program stored into the ROM by the CPU to totally control the image forming apparatus 10. In the present embodiment, the controller 100 includes a mode setting portion 101, a warm-up execution portion 102 (warm-up execution unit), a setting portion 103 (setting unit), and an image forming controller 104.

The mode setting portion 101 is adapted to set an operation mode of the image forming apparatus 10 to be a normal mode or a sleep mode. The sleep mode is set when the operating section 120 does not receive an operation input from a user for a predetermined period. The normal mode is resumed from the sleep mode when an operation input is received from a user through the operating section 120 in a state where the sleep mode is set.

Further, the mode setting portion 101 resumes the operation mode from the sleep mode when the FAX communication section 150 receives facsimile data in a state where the sleep mode is set.

Herein, the normal mode is a mode for allowing the power circuit 200 to supply rated electric power to respective devices constituting the image forming apparatus 10, and the sleep mode is a mode for allowing the power consumption of the image forming apparatus 10 to be lower than the amount of power consumed in the normal mode.

The warm-up execution portion 102 is adapted to execute a warm-up process including a prescribed color adjustment process by forming a certain toner image on the image forming section 190 at a time of activating the image forming apparatus 10 or at a time of resume from the sleep mode. When the setting portion 103 is set that the color adjustment process is not executed, the warm-up execution portion 102 executes the warm-up process to the image forming section 190 excluding the color adjustment process. Here, the time of activating the image forming apparatus 10 corresponds to a time of turning on a power switch through the operating section 120 for activating the image forming apparatus 10. When the power switch is turned on, the power circuit 200 starts to supply electric power from a commercial power source to the respective devices constituting the image forming apparatus 10.

The warm-up process includes a B/W (black & white) adjustment process and a color adjustment process. The B/W adjustment process includes a heating process for allowing the temperature of the fixing section 160 to reach a target temperature. The color adjustment process includes a color offset detection process of detecting a color offset in toner images of respective colors constituting a color image, and a density adjustment process of allowing respective densities of the toner images of respective colors constituting the color image to reach a target density.

The warm-up execution portion 102 executes the heating process so as to allow a heater 163 adapted to heat the fixing roller 162 to start heating of the fixing section 160 and then allow the heater 163 to stop the heating at a time when the temperature of the fixing heater 160 reaches the target temperature. The warm-up execution portion 102 compares the temperature of the fixing section 160 measured by the heater 163 with the predetermined target temperature to judge whether or not the temperature of the fixing section 160 reaches the target temperature. The target temperature is set to be a temperature at which a toner image can be fixed on recording paper.

The color offset detection process is a process for detecting positional offset of toner images of black (K), cyan (C), magenta (M), and yellow (Y) formed respectively by the four developing devices 207K-207Y which are adapted to form toner images of a plurality of color components (black, cyan, magenta, yellow) constituting a color image.

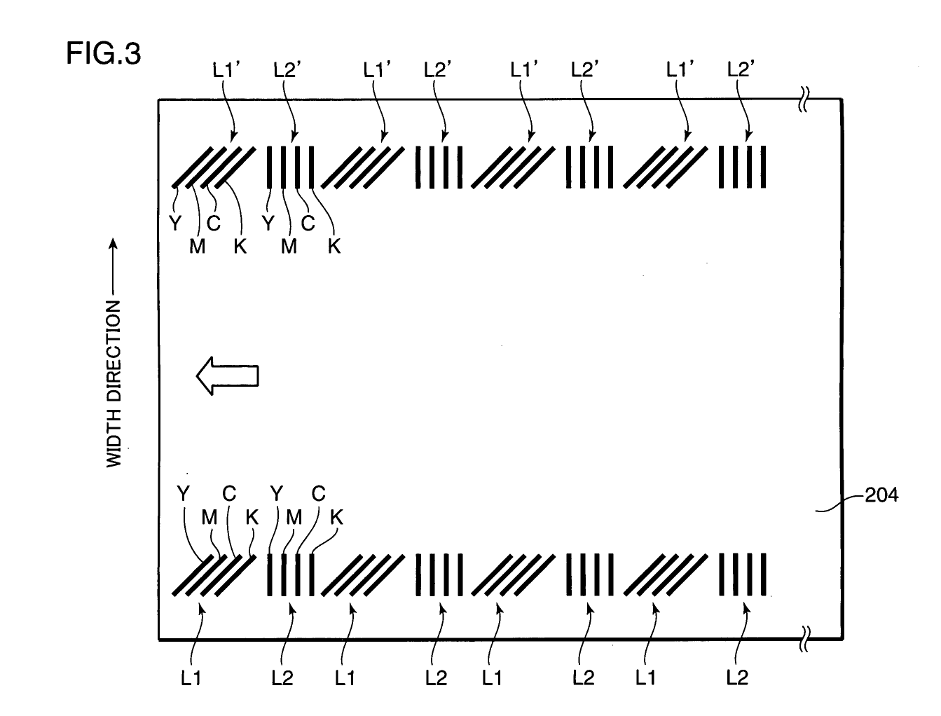

Here, the warm-up execution portion 102 detects positional offset in a method which is disclosed, for example, in Japanese Patent Unexamined Publication Nos. 2005-292760 and 2006-201624. Since details of the method are disclosed in Japanese Patent Unexamined Publication No. 2005-292760 or 2006-201624, only an overview of the color offset detection process will be described herein. The warm-up execution portion 102 controls the image forming section 190 to form color offset detection marks onto the intermediate transferring roller 204 as shown in FIG. 3, and allows the density measuring section 110 to read out the color offset detection marks, and detects offset of respective colors from one reference color among Y, M, C, K, and then stores the detected offset into an offset storage portion 142.

Here, the color offset detection marks include slanting lines L1 and horizontal lines L2 on one end side in a width direction (main scanning direction) of the intermediate transferring roller 204, and slanting lines L1′ and horizontal lines L2′ on other end side in a width direction of the intermediate transferring roller 204. The slanting lines L1 form a line pattern consisting of lines of four colors Y, M, C, K having a certain width and arranged a certain distance apart. The horizontal lines L2 form a line pattern of four colors having a certain width and arranged a certain distance apart on upstream of the slanting lines L1. The slanting lines L1′ form a line pattern consisting of lines of four colors Y, M, C, K having a certain width and arranged a certain distance apart. The horizontal lines L2′ form a line pattern of four colors having a certain width and arranged a certain distance apart on upstream of the slanting lines L1′. There are four sets of slanting lines L1 and horizontal lines L2, and they are arranged alternately. Also, there are four sets of slanting lines L1′ and horizontal lines L2′, and they are arranged alternately.

The density adjustment process is a process of determining a bias voltage applied to each of the developing devices 207K-207Y so as to allow the density of images formed respectively by the developing devices 207K-207Y to be a target density predetermined for obtaining a favorable image.

Here, the warm-up execution portion 102 uses a method disclosed in, for example, Japanese Patent Unexamined Publication No. HEI 6-194918 to execute the density adjustment process. Since details of the method are disclosed in Japanese Patent Unexamined Publication No. HEI 6-194918, only an overview of the density adjustment process will be described herein. The warm-up execution portion 102 controls the image forming section 190 to form a rectangular patch image onto the intermediate transferring roller 204, and allows the density measuring section 110 to read the patch image, and calculates respective bias voltages enabling the developing devices 207K-207Y to form the patch image at the predetermined target density in accordance with the result of reading, and then stores the bias voltages into a bias voltage storage portion 143. The warm-up execution portion 102 forms patch images of Y, M, C, K onto the intermediate transferring roller 204, and allows the density measuring section 110 to read the formed patch images of Y, M, C, K, and calculates respective bias voltages of the developing devices 207K-207Y, and then stores the bias voltages into the bias voltage storage portion 143.

The setting portion 103 enables a setting if the color adjustment process is to be executed or not at the time of execution of the warm-up process by the warm-up execution portion 102. Here, the setting portion 103 executes a setting if the color adjustment process is to be executed or not by storing setting information of “1” into a setting information storage portion 144 when the operating section 120 receives an operating instruction of not executing the color adjustment process at the time of execution of the warm-up process, and storing setting information of “0” into the setting information storage portion 144 when the operating section 120 receives an operating instruction of executing the color adjustment process at the time of execution of the warm-up process.

The image forming controller 104 executes a control to allow the image forming section 190 to form a toner image of a color or a B/W image obtained by the image obtaining section 130 onto recording paper. Here, when a color image consisting of color components of R, G, B is obtained by the image obtaining section 130, the image forming controller 104 forms a color toner image onto the intermediate transferring roller 204 by converting the color image from the RGB color co-ordinates to the Y, M, C, K color co-ordinates to create color component images of Y, M, C, K, outputting the created color component images to the image forming section 190 at a timing such that respective offset of the color component images having a reference color of one of Y, M, C, K becomes zero in accordance with the offset stored in the offset storage portion 142, and developing the outputted color component images at bias voltages calculated by the execution of the color offset detection process. It should be understood that the calculation process executed by the image forming controller 104 to calculate the timing of outputting the color component images so that color offset of the color component images becomes zero includes methods disclosed in Japanese Patent Unexamined Publication Nos. 2005-292760 and 2006-201624.

The image forming controller 104 controls the image forming section 190 to form the received facsimile data onto recording paper when the FAX communication section 150 receives facsimile data. Here, the FAX communication section 150 receives facsimile data as a B/W image, but it cannot receive facsimile data including a color image as a color image. Therefore, when the FAX communication section 150 receives facsimile data, the image forming controller 104 allows the image forming section 190 to form a B/W toner image.

The density measuring section 110 includes a reflection-type photo sensor arranged near the intermediate transferring roller 204. The density measuring section 110 measures the density of color offset detection marks formed on the intermediate transferring roller 204 at the time of execution of the color offset detection process, and the density of patch images formed on the intermediate transferring roller 204 at the time of execution of the density adjustment process.

The operating section 120 includes a power switch for turning on and off a power of the operating section 400 and the image forming apparatus shown in FIG. 1, and receives various kinds of instructions from a user.

The image obtaining section 130 includes the document reading section 500 shown in FIG. 1, and obtains a color or a B/W image by reading out a document. Here, the image obtaining section 130 obtains a color image when the operating section 120 receives an operating instruction of reading a color image, and obtains a B/W image when the operating section 120 receives an operating instruction of reading a B/W image.

The storage section 140 includes a hard disk drive, and is provided with an image memory 141, the offset storage portion 142, the bias voltage storage portion 143, and the setting information storage portion 144. The image memory 141 stores a color or a B/W image obtained by the image obtaining section 130. The offset storage portion 142 stores respective offset of color images having a reference color of one of Y, M, C, K, which are found by the execution of the color offset detection process. The bias voltage storage portion 143 stores respective bias voltages of the developing devices 207K-207Y, which are found by the execution of the density adjustment process. The setting information storage portion 144 stores setting information set by the setting portion 103.

The FAX communication section 150 includes a modem and receives facsimile data transmitted according to a facsimile transmission standard. Here, the FAX communication section 150 receives facsimile data of a B/W image as image data, but it cannot receive facsimile data including a color image as a color image.

The fixing section 160 corresponds to the fixing roller 208 shown in FIG. 1, and includes a temperature sensor 161, the fixing roller 162, and the heater 163 to fix a toner image onto recording paper. The temperature sensor 161 includes a thermister arranged near the fixing roller 162 to measure the temperature of the fixing section 160. The fixing roller 162 includes a driving roller driven by an electromagnetic clutch which is one of a pair of rollers constituting the fixing roller 208 shown in FIG. 1. The heater 163 includes an IH heater to heat the fixing roller 162.

The conveying portion 180 has a plurality of sheet feeding rollers 202 and an electromagnetic clutch for driving the sheet feeding rollers 202. Under a control executed by the image forming controller 104, the conveying portion 180 conveys recording paper.

The image forming section 190 includes the transferring roller 203, the intermediate transferring roller 204, the photoconductive drum 205, the exposing device 206, and the developing device 207Y-207K which are shown in FIG. 1. The image forming section 190 forms a toner image on the recording paper under a control executed by the image forming controller 104, and forms color offset detection marks and a patch image onto the intermediate transferring roller 204 under a control executed by the warm-up execution portion 102.

The power circuit 200 supplies electric power from the commercial power source to respective devices constituting the image forming apparatus 10 when the power switch is turned on. The power circuit 200 shuts down the supply of power from the commercial power source to the respective devices when the power switch is turned off. Further, when the operation mode is set to be the sleep mode, the power circuit 200 shuts down the power supply to some of the devices constituting the image forming apparatus 10 or make the power supply be lower than the rated electric power so as to lower the amount of consumption of electric power of the image forming apparatus 10. On the other hand, when the operation mode is set to be the normal mode, the power circuit 200 supplies the rated electric power to the respective devices constituting the image forming apparatus 10.

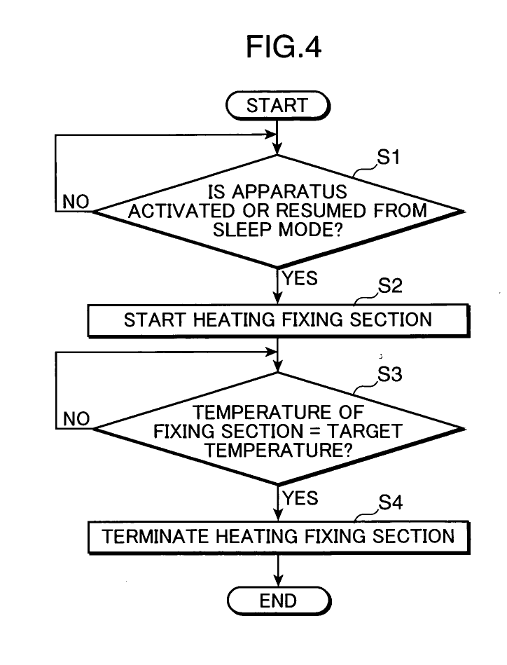

Next, an operation of the image forming apparatus 10 at the time of execution of the warm-up process will be described. FIG. 4 is a flowchart showing processes which are executed at the time of execution of the warm-up process excluding the color adjustment process. It should be understood that the setting portion 103 stores setting information of “1” into the setting information storage portion 144 before execution of the processes of the flowchart, so that it is set that the color adjustment process is not executed at the time of execution of the warm-up process.

Firstly, when the power switch is turned on to activate the main power source of the image forming apparatus 10 or to allow the mode setting portion 101 to resume the operation mode from the sleep mode to the normal mode (YES in step S1), the warm-up execution portion 102 starts electric supply to the heater 163 to allow the heater 163 to start heating the fixing section 160 (step S2).

Next, when it is determined that the temperature of the fixing section 160 reaches the target temperature (YES in step S3), the warm-up execution portion 102 terminates heating to the fixing section 160 (step S4). On the other hand, when it is determined that the temperature of the fixing section 160 does not reach the target temperature (NO in step S3), the warm-up execution portion 102 allows the routine to go back to the process of step S3. In other words, the warm-up execution portion 102 allows the heater 163 to keep heating the fixing section 160 until the temperature of the fixing section 160 reaches the target temperature. Then, when the temperature of the fixing section 160 reaches the target temperature, the warm-up execution portion 102 terminates the warm-up process without execution of the color adjustment processing including the color offset detection process and the density adjustment process.

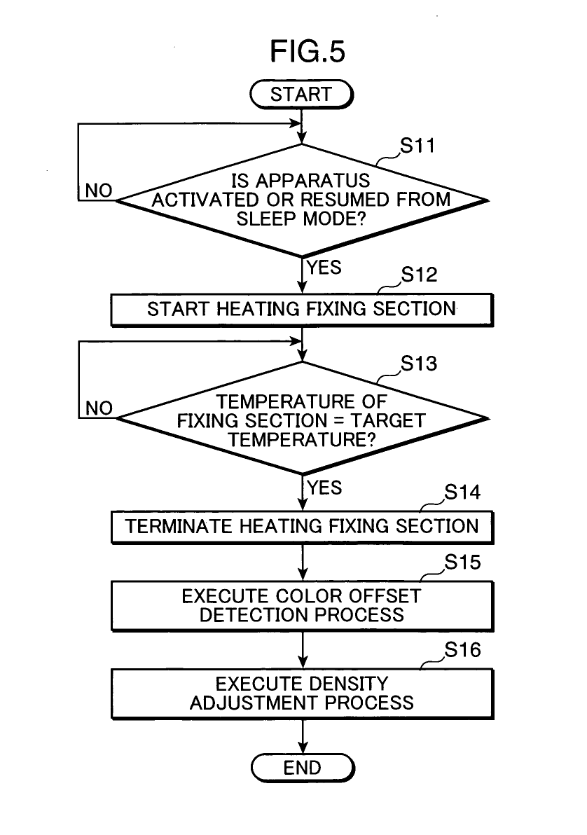

FIG. 5 is a flowchart showing a process which is executed at the time of execution of the warm-up process including the color adjustment process.

It should be understood that the setting portion 103 stores setting information of “0” into the setting information storage portion 144 before execution of the processes of the flowchart, so that it is set that the color adjustment process is executed at the time of execution of the warm-up process.

The processes of steps S11 through S14 are the same as those of the steps S1 through S4 shown in FIG. 4. Accordingly, descriptions of those will be omitted. In step S15, the warm-up execution portion 102 allows the image forming section 190 to form a color offset detection pattern like the one shown in FIG. 3 onto the intermediate transferring roller 204 to execute the color offset detection process (step S15). Next, the warm-up execution portion 102 allows the image forming section 190 to form patch images of K, C, M, Y onto the intermediate transferring roller 204 to execute the density adjustment process (step S16), and finds bias voltages of the respective developing devices 207K-207Y, and then terminates the process.

As described above, according to the image forming apparatus 10, the warm-up process excluding the color adjustment process is executed when it is set that the color adjustment process by forming a toner image on the image forming section 190 at the time of execution of the warm-up process is not executed. Accordingly, in the image forming apparatus 10 which mainly performs printing of a B/W image, the color adjustment process is not executed at the time of execution of the warm-up process, so that wasteful consumption of toners can be prevented.

Further, when a B/W image transmitted in accordance with the facsimile transmission standard is received in the state where the sleep mode is set, and it is set that the color adjustment process is not executed at the time of execution of the warm-up process, the warm-up process excluding the color adjustment process is executed. Consequently, the time taken by the warm-up process is shortened, so that the B/W image included in the received facsimile data can be quickly formed onto recording paper.

In the above-described embodiment, when a B/W image transmitted in accordance with the facsimile transmission standard is received in the state where the sleep mode is set, and it is set that the color adjustment process is not executed at the time of execution of the warm-up process, the warm-up process excluding the color adjustment process is executed. However, it should be understood that the present invention is not limited to this. When the B/W image transmitted in accordance with the facsimile transmission standard is received in the state where the sleep mode is set, the warm-up process excluding the color adjustment process may be executed, regardless of whether or not its is set that the color adjustment process is not executed at the time of execution of the warm-up process.

In the above, a copying machine is described as an example of the image forming apparatus in accordance with the present invention. In other words, the setting portion 103 shown in FIG. 2 corresponds to a setting unit of setting whether or not the color adjustment process is executed at the time of execution of the warm-up process, and the operating section 400 shown in FIG. 1 or the operating section 120 shown in FIG. 2 is used in an actual setting.

However, an image forming apparatus expected in the present application is not limited to a copying machine, but it may be adopted in a printer. In such case, a setting unit for setting whether or not the color adjustment process is executed at the time of execution of the above-described warm-up process has a configuration which enables execution of the setting selection process through a setting screen of a printer driver which is installed in an equipment such as a personal computer connected to the printer.

In summary, an image forming apparatus comprises: an image forming unit, which forms a B/W or a color image on a recording paper; a warm-up execution unit, which executes a warm-up process including a prescribed color adjustment process by forming a certain toner image on the image forming unit at a time of resume from a sleep mode or at a time of activating the apparatus; and a setting unit, which enables a setting if said color adjustment process is to be executed or not at the time of execution of the warm-up process. Said warm-up execution unit executes said warm-up process to the image forming unit excluding the color adjustment process when the setting unit is set that the color adjustment process is not executed.

According to this configuration, the warm-up process excluding the color adjustment process is executed when it is set that the color adjustment process by forming a toner image on the image forming unit is not executed at the time of execution of the warm-up process. Accordingly, the color adjustment process is not executed at the time of execution of the warm-up process in the image forming apparatus which mainly performs printing of a B/W image, so that wasteful consumption of toners can be prevented.

Further, it is preferable that the image forming apparatus further comprises: a communication unit, which receives facsimile data including a B/W image, and said warm-up execution unit executes the warm-up process when the communication unit receives facsimile data in a state where a sleep mode is set, and executes the warm-up process excluding said color adjustment process when said setting unit is set that the color adjustment process is not executed.

According to this configuration, the warm-up process excluding the color adjustment is executed when facsimile data including a B/W image is set in a state where the sleep mode is set, and it is set that said color adjustment process is not executed at the time of execution of the warm-up process. Accordingly, a wasteful consumption of toners can be prevented, and the time for execution of the warm-up process is shortened, so that the B/W image included in the received facsimile data can be quickly formed on recording paper.

Further, it is preferable that the image forming apparatus further comprises: a communication unit, which receives facsimile data including a B/W image, and said warm-up execution unit executes the warm-up process excluding the color adjustment process regardless of whether or not said setting unit is set that the color adjustment process is not executed when said communication unit receives facsimile data in a state where a sleep mode is set.

According to this configuration, a wasteful consumption of toners can be prevented, and the time for execution of the warm-up process is shortened, so that the B/W image included in the received facsimile data can be quickly formed on recording paper.

Further, it is preferable that said image forming unit includes: a developing device, which forms toner images of respective color components constituting the color image; and a fixing device, which allows a toner image developed by the developing device to be fixed on the recording paper, and said color adjustment process includes a color offset detection process for detecting a color offset in the toner image of respective color components.

According to this configuration, the color offset detection process for detecting a color offset in the toner image is not executed when it is set that the color adjustment process is not executed at the time of execution of the warm-up process.

Further, it is preferable that said color adjustment process includes a density adjustment process for allowing respective densities of toner images of the color components to be a prescribed target density.

According to this configuration, the density adjustment process is not executed when it is set that the color adjustment process is not executed at the time of execution of the warm-up process.

Further, it is preferable that the warm-up process excluding the color adjustment process includes a heating process for allowing the temperature of the fixing unit to be a prescribed target temperature.

According to this configuration, the heating process is executed when it is set that the color adjustment process is not executed at the time of execution of the warm-up process.

This application is based on Japanese Patent Application Serial No. 2006-341337 filed in Japan Patent Office on Dec. 19, 2006, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus comprising:
an image forming unit, which forms a B/W or a color image on a recording paper;
a warm-up execution unit, which executes a warm-up process including a prescribed color adjustment process by forming a certain toner image on the image forming unit at a time of resume from a sleep mode or at a time of activating the apparatus; and
a setting unit, which enables a setting if said color adjustment process is to be executed or not at the time of execution of the warm-up process;
wherein said warm-up execution unit executes said warm-up process to the image forming unit excluding the color adjustment process when the setting unit is set that the color adjustment process is not executed.

2. The image forming apparatus according to claim 1, further comprising: a communication unit, which receives facsimile data including a B/W image,
wherein said warm-up execution unit executes the warm-up process when the communication unit receives facsimile data in a state where a sleep mode is set, and executes the warm-up process excluding said color adjustment process when said setting unit is set that the color adjustment process is not executed.

3. The image forming apparatus according to claim 1, further comprising a communication unit, which receives facsimile data including a B/W image,
wherein said warm-up execution unit executes the warm-up process excluding the color adjustment process regardless of whether or not said setting unit is set that the color adjustment process is not executed when said communication unit receives facsimile data in a state where a sleep mode is set.

4. The image forming apparatus according to claim 1,
wherein said image forming unit includes:
a developing device, which forms toner images of respective color components constituting the color image; and
a fixing device, which allows a toner image developed by the developing device to be fixed on the recording paper, and
wherein said color adjustment process includes a color offset detection process for detecting a color offset in the toner image of respective color components.

5. The image forming apparatus according to claim 4, wherein said color adjustment process includes a density adjustment process for allowing respective densities of toner images of the color components to be a prescribed target density.

6. The image forming apparatus according to claim 1, wherein the warm-up process excluding the color adjustment process includes a heating process for allowing the temperature of the fixing unit to be a prescribed target temperature.

7. A method for warming up an image forming apparatus which includes an image forming unit for forming a B/W or a color image on a recording paper, the method comprising the steps of:
setting whether or not a color adjustment process is executed at a time of execution of a warm-up process including a B/W adjustment process and said color adjustment process;
detecting a setting of not executing said color adjustment process;
detecting whether or not an operation mode of said image forming apparatus is resumed from a sleep mode or a state of deactivation to a normal mode;
starting said B/W adjustment process in accordance with detection of the resume to said normal mode;
determining whether or not said B/W adjustment process satisfies a prescribed condition; and
terminating said warm-up process without execution of said color adjustment process when it is detected that said B/W adjustment process satisfies said prescribed condition.

8. The method according to claim 7, wherein said image forming apparatus further comprises a communication unit, which receives facsimile data including a B/W image,
wherein said warm-up execution unit executes the warm-up process without execution of said color adjustment process when the communication unit receives facsimile data in a state where a sleep mode is set.

9. The method according to claim 7, wherein said image forming apparatus further comprises a communication unit, which receives facsimile data including a B/W image,
wherein said warm-up execution unit executes the warm-up process without execution of said color adjustment process regardless of whether or not said setting unit is set that the color adjustment process is not executed when said communication unit receives facsimile data in a state where a sleep mode is set.

10. The method according to claim 7,
wherein said image forming unit includes:
a developing device, which forms toner images of respective color components constituting the color image; and
a fixing device, which allows a toner image developed by the developing device to be fixed on the recording paper, and
wherein said color adjustment process includes a color offset detection process for detecting a color offset in the toner image of respective color components.

11. The method according to claim 10, wherein said color adjustment process includes a density adjustment process for allowing respective densities of toner images of the color components to be a prescribed target density.

12. The method according to claim 7, wherein said B/W adjustment process includes a heating process for raising the temperature of the fixing unit which allows the toner image developed by a developing device to be fixed on recording paper, and said prescribed condition includes a prescribed target temperature of the fixing unit.
